(19) United States
(12) Patent Application Publication
(10) Pub. No.: US 2012/0047387 A1
(43) Pub. Date: Feb. 23, 2012

(54) Cache control device and cache control method

(75) Inventor: Hideki Sakata, Kawasaki (JP)

(73) Assignee: FUJITSU LIMITED, Kawasaki-shi (JP)

(21) Appl. No.: 13/373,048

(22) Filed: Nov. 3, 2011

Related U.S. Application Data
(63) Continuation of application No. PCT/JP09/59871, filed on May 29, 2009.

(51) Int. Cl. G06F 11/30

(52) U.S. Cl. 713/340

(57) ABSTRACT

A cache control device includes, in a secondary cache data unit, a clean area that stores only information that is the same information as that stored in a main storage. Then, the cache control device monitors information on electrical power consumption of the cache control device, determines whether the information on the electrical power consumption is equal to or greater than a predetermined threshold, monitors an activity ratio of a cache memory, and determines whether the activity ratio is equal to or less than a predetermined threshold. Subsequently, if the cache control device determines that the information on the electrical power consumption is equal to or greater than the predetermined threshold or determines that the activity ratio of the secondary cache memory is equal to or less than the predetermined threshold, the cache control device performs control such that the clean area in the secondary cache data unit is degenerated.

### CROSS-REFERENCE TO RELATED APPLICATION

This application is a continuation application of International Application No. JP2009/059871, filed on May 29, 2009, and designated the U.S., the entire contents of which are incorporated herein by reference.

### FIELD

The embodiments discussed herein are directed to a cache control device and a cache control method.

### BACKGROUND

The conventional way to speed up a process is to use a cache control circuits that save data in, instead of main storages, cache memories running at a high access speed. In recent years, with such cache control circuits, as the semiconductor manufacturing technology is improved and the size of the circuits becomes smaller, a large amount of electrical power consumption is consumed due to an increase in the degree of integration and in the leakage current. Accordingly, saving electrical power in such cache control circuits has been drawing attention. (for example, see Japanese Laid-open Patent Publication No. 08-45275, No. 02-040194, No. 09-274796, No. 02-310762, No. 2008-146812, No. 08-8991, and No. 11-177637).

For example, to save electrical power, there is a known technology for controlling operation clocks or voltages in such a manner that they vary (for example, see Japanese Laid-open Patent Publication No. 5-94227 and No. 2004-303206). Specifically, an external circuit that controls the operation clock or an external circuit that controls the variation in the voltages is arranged in a cache control circuit. These external circuits vary the operation clocks or the voltages.

Furthermore, to save electrical power, there is also a known technology for temporarily disconnecting a cache memory when electrical power consumption is high (for example, see Japanese Laid-open Patent Publication No. 2001-109729 and No. 02-151950 and Japanese National Publication of International Patent Application No. 2003-530640). Specifically, when electrical power consumption is determined to be high, dirty data, which is not stored in a main storage and is present only in the cache memory, is written to the main storage from a cache memory and then the cache memory is disconnected.

However, with the technology for varying the operation clocks or the voltages, it is preferable to use an external circuit that controls the operation clocks or preferable to use a complex external circuit that is used to control the variation in the voltages. Accordingly, there is a problem in that the size of the circuit becomes large and thus manufacturing costs increase.

Furthermore, with the technology for disconnecting the cache memory, because the dirty data stored in the cache memory is written to the main storage, there may be a case in which the processing loads for writing the dirty data to the main storage becomes high, and thus the time before disconnecting the cache memory increases. Accordingly, there is a problem in that electrical power consumption is difficult to be reduced.

### SUMMARY

According to an aspect of an embodiment of the invention, a cache control device includes a cache memory that includes an identical-information storage area that stores therein data that is the same data as that stored in a main storage; an electrical power consumption monitoring unit that monitors electrical power consumption information of the cache control device and that determines whether the electrical power consumption information indicates that the electrical power consumption is equal to or greater than a predetermined threshold; an activity ratio monitoring unit that monitors an activity ratio of the cache memory and that determines whether the activity ratio is equal to or less than a predetermined threshold; and a degeneracy control unit that degenerates the identical-information storage area in the cache memory when the electrical power consumption monitoring unit determines that the electrical power consumption information indicates that the electrical power consumption is equal to or greater than the predetermined threshold or when the activity ratio monitoring unit determines that the activity ratio is equal to or less than the predetermined threshold.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating the configuration of an information processing apparatus according to a first embodiment;

FIG. 2 is a schematic diagram illustrating the configuration of data in a secondary cache directory unit;

FIG. 3 is a flowchart illustrating the flow of a disconnection process and a revert process performed by a cache control device according to the first embodiment; and

FIGS. 4A and 4B are flowcharts illustrating the flow of a cache registration process performed by the cache control device according to the first embodiment.

### DESCRIPTION OF EMBODIMENTS

Preferred embodiments of the present invention will be explained with reference to accompanying drawings.

### [a] First Embodiment

In the following embodiment, the configuration of the cache control device according to the first embodiment and the flow of processing thereof are described in the order they are listed in this sentence. Finally, an advantage of the first embodiment will be described.

Configuration of the cache control device

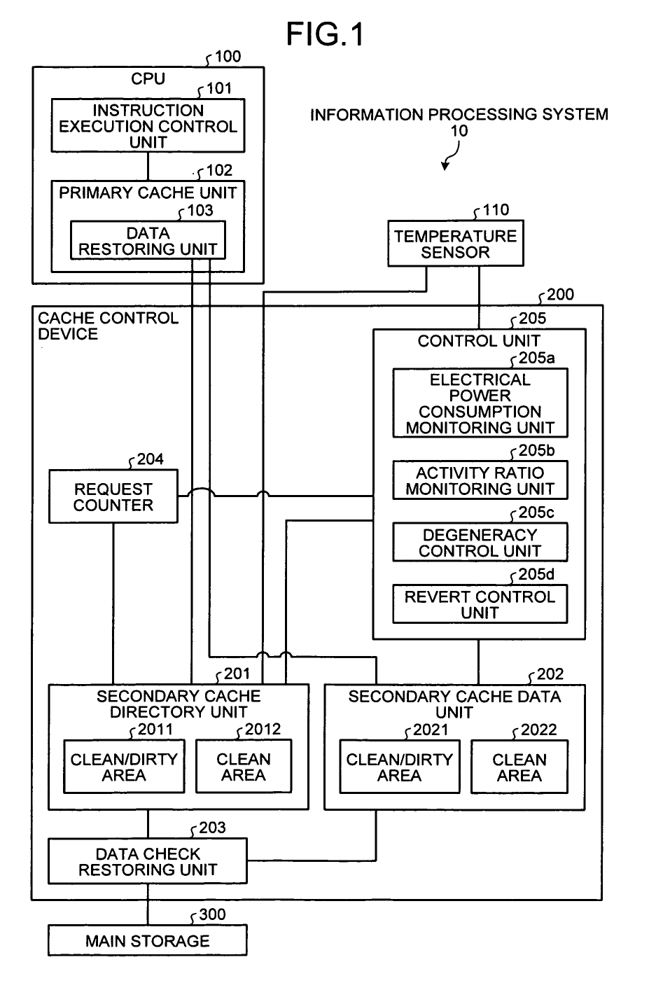

First, the configuration of an information processing system 10 that includes a cache control device 200 according to the first embodiment will be described with reference to FIG. 1. FIG. 1 is a block diagram illustrating the configuration of the cache control device 200 according to the first embodiment.

As illustrated in FIG. 1, the information processing system 10 includes a CPU (Central Processing Unit) 100, a temperature sensor 110, the cache control device 200, and a main storage 300, which are connected each other via a bus or the like. Processes performed by these devices will be described below.

The CPU 100 is a processor core block and includes an instruction execution control unit 101 and a primary cache unit 102. The instruction execution control unit 101 extracts an instruction from the main storage 300 via a primary cache and performs the execution and processing of the instruction.

The primary cache unit 102 includes a data restoring unit 103, receives a request from the instruction execution control unit 101, and accesses data registered in the primary cache. If the data is not registered in the primary cache, the primary cache unit 102 accesses a secondary cache. The temperature sensor 110 measures the temperature of the cache control device 200 and notifies a control unit 205 in the cache control device 200 of the temperature information.

The data restoring unit 103 restores data received from the cache control device 200. Specifically, when receiving data and a data invert flag from the cache control device 200, the data restoring unit 103 determines whether the data is to be inverted using the invert flag. More specifically, if the data invert flag is “1”, the data restoring unit 103 inverts the data and restores the inverted data.

When receiving a request from the primary cache unit 102, the cache control device 200 accesses data registered in the secondary cache. If the data is not registered in the secondary cache, the cache control device 200 accesses the main storage 300. In contrast, if the data is registered in the secondary cache, the cache control device 200 reads the data from a data unit and makes a response to the primary cache unit 102.

Furthermore, the cache control device 200 includes a secondary cache directory unit 201, a secondary cache data unit 202, a data check restoring unit 203, a request counter 204, and the control unit 205. Processes performed by these units will described below.

The secondary cache directory unit 201 records therein status information on the status of the data registered in the secondary cache data unit 202. Furthermore, the secondary cache directory unit 201 includes a clean/dirty area 2011 that stores therein status information on clean registration data and status information on dirty registration data. The secondary cache directory unit 201 also includes a clean area 2012 that stores therein only status information on clean registration data.

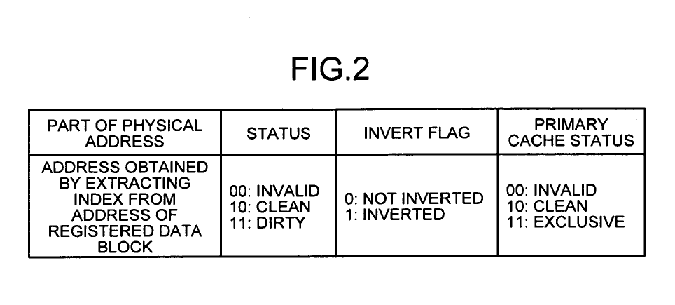

In the following, the status information stored in the secondary cache directory unit 201 will be specifically described. FIG. 2 is a schematic diagram illustrating the configuration of data in a secondary cache directory unit. As illustrated in FIG. 2, the secondary cache directory unit 201 stores therein a “physical address” indicating the address of registration data, a “status” indicating the status of the registration data in the secondary cache, an “invert flag” indicating the status of the registration data, and a “primary cache status” indicating the status of the registration data in the primary cache.

For example, in the “status” indicating the status of the registration data in the secondary cache, the status of “00:invalid” indicates that the registration data is invalid, the status of “10:clean” indicates that the registration data matches data in the main storage 300, and the status of “11:dirty” indicates that the registration data does not match data in the main storage 300.

Furthermore, for example, if the “invert flag” indicating the status of the registration data is “0”, the registration data is registered as it is. If the “invert flag” is “1”, the registration data is inverted and registered.

Furthermore, for example, in the “primary cache status” indicating the status of the registration data in the primary cache, the status of “00:invalid” indicates that the registration data is invalid, the status of “10:clean” indicates that the registration data matches data in the main storage 300, and the status of “11:exclusive” indicates that the registration data does not match data in the main storage 300.

The secondary cache data unit 202 stores therein the main body of the recorded data. Furthermore, the secondary cache data unit 202 includes a clean/dirty area 2021 that stores therein clean registration data and dirty registration data and a clean area 2022 that stores therein only clean registration data.

Specifically, the secondary cache data unit 202 has an area substantially divided into two, i.e., the clean/dirty area 2021 and the clean area 2022. It is possible to divide the area, for example, in the way direction. The dirty data mentioned here means data updated by the CPU 100, not stored in the main storage 300, and only present in the cache memory. In contrast, the clean data mentioned here means data that is the same as data stored in the main storage 300.

In the following, a process for allocating data to be registered in the clean/dirty area 2021 or the clean area 2022 will be described. The flow of the process will be described in detail later with reference to FIG. 5. If a request received from the CPU 100 is a store instruction, the data may possibly be dirty data; therefore, the secondary cache data unit 202 registers the data in the clean/dirty area 2021. If a request received from the CPU 100 is a read instruction, the data is clean data; therefore, the secondary cache data unit 202 registers the data in the clean area 2022 or the clean/dirty area 2021.

The data check restoring unit 203 counts the number of “1”s contained in the data. If the result of the check is that “1”s make up more that half of the length of the data, the data check restoring unit 203 sends the inverted data to the secondary cache data unit 202. If not, the data check restoring unit 203 sends the data without processing anything. Furthermore, if the data is inverted, the data check restoring unit 203 notifies the secondary cache directory unit 201 that the data is inverted. Furthermore, at the time of the write back, the data check restoring unit 203 receives an invert flag from the secondary cache directory unit 201 and sends restored data to the main storage 300.

The request counter 204 measures the number of requests sent to the secondary cache in a predetermined period of time and notifies the control unit 205 of this number. The control unit 205 performs a degeneracy control process and a revert control process on the secondary cache data unit 202. The control unit 205 includes an electrical power consumption monitoring unit 205a, an activity ratio monitoring unit 205b, a degeneracy control unit 205c, and a revert control unit 205d.

The electrical power consumption monitoring unit 205a monitors information on electrical power consumption of the cache control device 200 and determines whether the information on the electrical power consumption indicates that the electrical power consumption is equal to or greater than a predetermined threshold. Specifically, the electrical power consumption monitoring unit 205a receives, from the temperature sensor 110 as information on the electrical power consumption, temperature information and determines whether the temperature of the cache control device 200 is equal to or greater than the predetermined threshold. If the result of the determination is that the temperature of the cache control device 200 is equal to or greater than the predetermined threshold, the electrical power consumption monitoring unit 205a notifies the degeneracy control unit 205c of it.

Furthermore, after the degeneracy control is performed by the degeneracy control unit 205c, the electrical power consumption monitoring unit 205a receives temperature information from the temperature sensor 110 and determines whether the temperature of the cache control device 200 is equal to or less than a predetermined threshold. If the result of the determination is that the temperature of the cache control device 200 is equal to or less than the predetermined threshold, the electrical power consumption monitoring unit 205a notifies the revert control unit 205d of it.

The activity ratio monitoring unit 205b monitors the activity ratio of the secondary cache memory and determines whether the secondary cache memory activity ratio is equal to or less than a predetermined threshold. Specifically, the activity ratio monitoring unit 205b receives, as the activity ratio of the secondary cache memory, the number of requests sent from the request counter 204 to the secondary cache in a predetermined period of time and determines whether the number of requests is equal to or less than the predetermined threshold. If the result of the determination is that the number of requests is equal to or less than a predetermined threshold, the activity ratio monitoring unit 205b notifies the degeneracy control unit 205c of it.

Furthermore, after the degeneracy control is performed by the degeneracy control unit 205c, the activity ratio monitoring unit 205b receives the number of requests sent from the request counter 204 to the secondary cache in a predetermined period of time and determines whether the number of requests is equal to or greater than the predetermined threshold. If the result of the determination is that the number of requests is equal to or greater than the predetermined threshold, the electrical power consumption monitoring unit 205a notifies the revert control unit 205d of it.

If it is determined that the information on the electrical power consumption indicates that the electrical power consumption is equal to or greater than the predetermined threshold or if it is determined that the activity ratio is equal to or less than the predetermined threshold, the degeneracy control unit 205c controls the clean area 2022 in the secondary cache data unit 202 such that the clean area 2022 is degenerated. Specifically, if the degeneracy control unit 205c receives a notification from the electrical power consumption monitoring unit 205a indicating that the temperature of the cache control device 200 is equal to or greater than the predetermined threshold, the electrical power consumption monitoring unit 205a promptly disconnects the clean area 2022 in the secondary cache data unit 202.

Furthermore, if the degeneracy control unit 205c receives, from the activity ratio monitoring unit 205b, a notification indicating that the number of requests is equal to or less than the predetermined threshold, the degeneracy control unit 205c resets the clean area 2012 in the secondary cache directory unit 201. After the reset has been completed, the degeneracy control unit 205c disconnects the clean area 2022 in the secondary cache data unit 202.

In other words, by performing the disconnection process, the electrical power consumed by the disconnected clean area 2022 can be reduced. Furthermore, a cache miss frequently occurs due to the disconnection of the clean area 2022, and therefore the number of accesses to the main storage 300 increases. Accordingly, the activity ratio of the CPU 100 decreases, thus reducing the electrical power for the operation of the CPU 100.

Because the clean data is stored in the main storage 300, even when the clean area 2022 in which the clean data is registered is disconnected, the data can be obtained by accessing again the main storage 300. Accordingly, in the disconnection process, dirty data does not need to be written to the main storage; therefore, it is possible to immediately perform the degeneracy control process.

Examples of methods for disconnecting the clean area 2022 in the secondary cache data unit 202 includes a method for inhibiting access, a method for inhibiting the application of a clock, and a method for stopping a power supply using a power gate; however, any method can be used as long as the electrical power consumption can be reduced.

If it is determined that information on the electrical power consumption indicates that the electrical power consumption is equal to or less than the predetermined threshold or if it is determined that the activity ratio is equal to or greater than the predetermined threshold, the revert control unit 205d controls the clean area 2022 in the secondary cache data unit 202 such that the clean area 2022 is reverted.

Specifically, if the revert control unit 205d receives, from the electrical power consumption monitoring unit 205a, a notification indicating that the temperature of the cache control device 200 is equal to or less than the predetermined threshold, the revert control unit 205d determines that the temperature state has been recovered, resets the clean area 2012 in the secondary cache directory unit 201, and, after the reset, re-connects the clean area 2022 in the secondary cache data unit 202.

Furthermore, if the revert control unit 205d receives, from the activity ratio monitoring unit 205b, a notification indicating that the number of requests is equal to or greater than the predetermined threshold, the revert control unit 205d promptly re-connects the clean area 2022 in the secondary cache data unit 202.

Specifically, if the temperature of the cache control device 200 is equal to or greater than the predetermined threshold, the electrical power consumption is excessive and thus the electrical power needs to be promptly reduced. Accordingly, the cache control device 200 promptly disconnects the clean area 2022 without resetting the clean area 2012 in the secondary cache directory unit 201. Then, the cache control device 200 resets the clean area 2012 in the secondary cache directory unit 201 after the state in which the electrical power consumption is excessive is resolved and immediately before re-connecting the clean area 2022 in the secondary cache data unit 202.

In contrast, if the number of requests sent to the secondary cache is equal to or less than the predetermined threshold, the electrical power consumption is not excessive and thus the electrical power does not need to be promptly reduced. Accordingly, the cache control device 200 resets the clean area 2012 in the secondary cache directory unit 201 and then disconnects the clean area 2022. Thereafter, if the number of requests to the secondary cache is equal to or greater than the predetermined threshold, the cache control device 200 promptly re-connects the clean area 2022 in the secondary cache data unit 202 because the clean area 2022 needs to be immediately reverted.

The main storage 300 includes a main memory for the information processing apparatus and stores therein all the instructions and data used for processing performed by the CPU 100. From among the instructions and the data, frequently used instructions and data are stored in the secondary cache data unit 202 or the primary cache unit 102 in the CPU 100.

Process performed by the cache control device

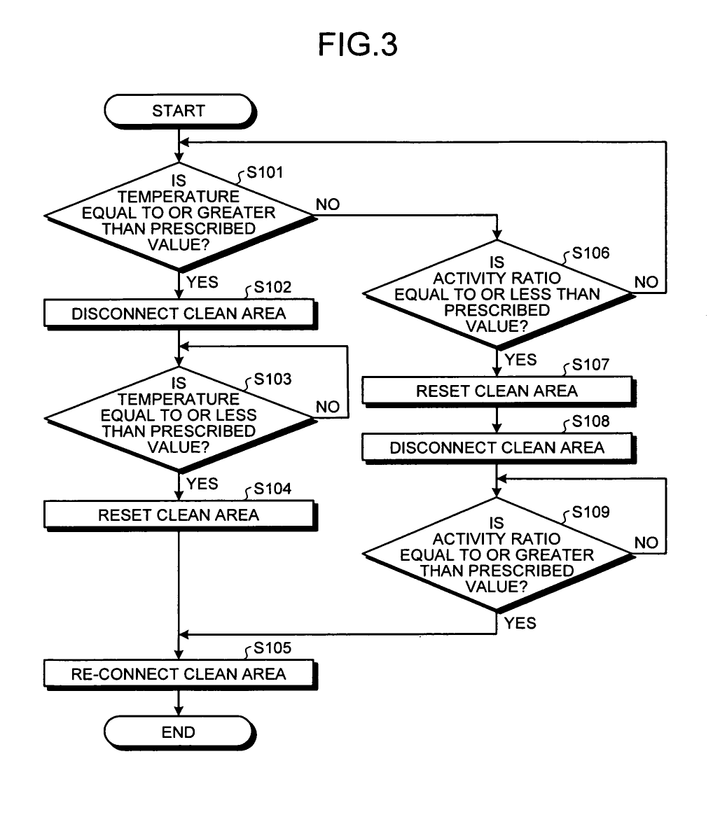

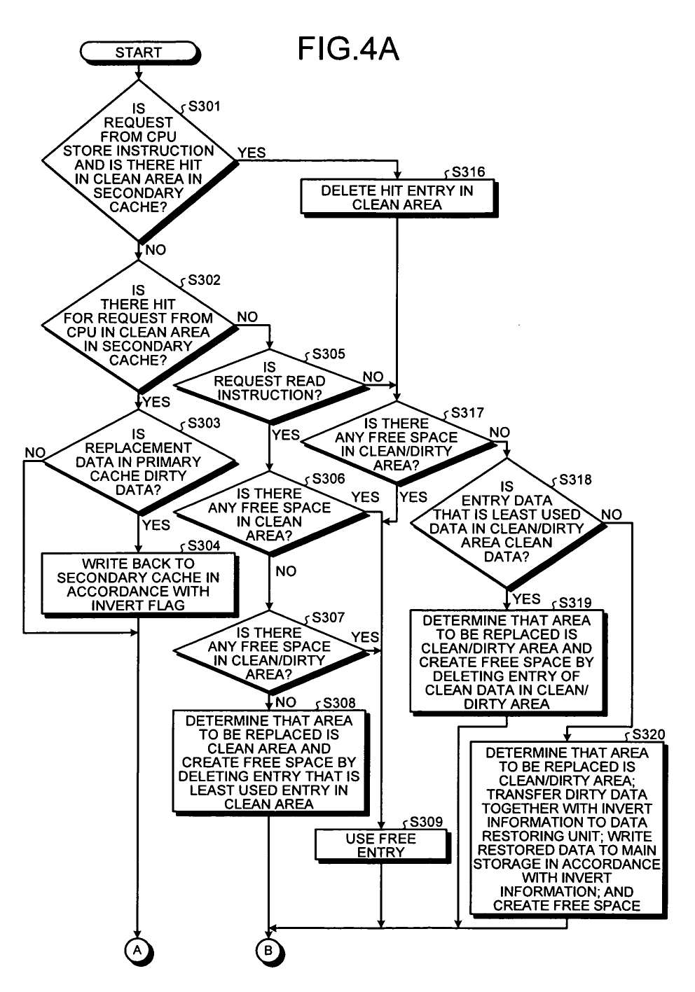

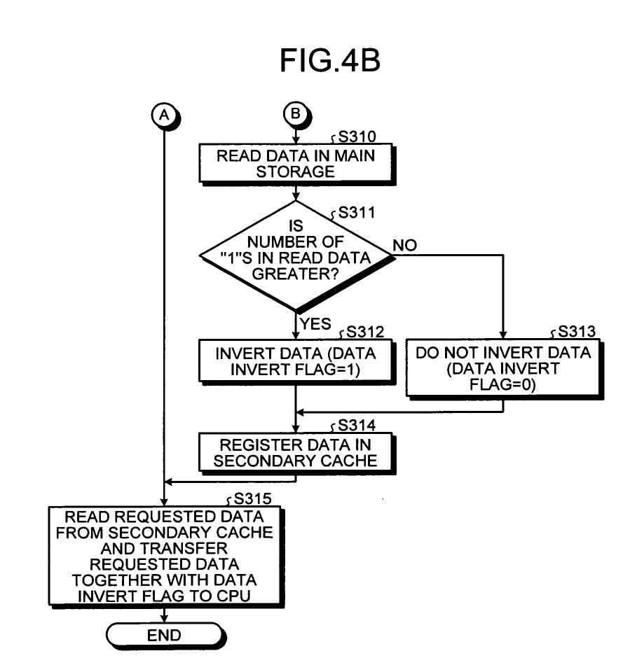

In the following, a process performed by the cache control device 200 according to the first embodiment will be described with reference to FIGS. 3, 4A and 4B. FIG. 3 is a flowchart illustrating the flow of a disconnection process and a revert process performed by a cache control device according to the first embodiment. FIGS. 4A and 4B are flowcharts illustrating the flow of a cache registration process performed by the cache control device according to the first embodiment.

As illustrated in FIG. 3, the electrical power consumption monitoring unit 205a in the cache control device 200 receives temperature information as information on electrical power consumption from the temperature sensor 110 and determines whether a temperature of the cache control device 200 is equal to or greater than the predetermined threshold (Step S101). If the result of the determination is that the temperature of the cache control device 200 is equal to or greater than a predetermined threshold (Yes at Step S101), the degeneracy control unit 205c promptly disconnects the clean area 2022 in the secondary cache data unit 202 (Step S102).

Then, after the degeneracy control is performed by the degeneracy control unit 205c, the electrical power consumption monitoring unit 205a receives temperature information from the temperature sensor 110 and determines whether a temperature of the cache control device 200 is equal to or less than the predetermined threshold (Step S103).

If the result of the determination is that the temperature of the cache control device 200 is equal to or less than the predetermined threshold (Yes at Step S103), the revert control unit 205d resets the clean area 2012 in the secondary cache directory unit 201 (Step S104), and, after the completion of the reset, re-connects the clean area 2022 in the secondary cache data unit 202 (Step S105).

In contrast, if it is determined that the temperature of the cache control device 200 is not equal to or greater than the predetermined threshold (No at Step S101), the activity ratio monitoring unit 205b determines whether, as the activity ratio of the secondary cache memory, the number of requests is equal to or less than a predetermined threshold (Step S106). If the result of the determination is that the number of requests is not equal to or less than the predetermined threshold (No at Step S106), the process returns to Step S101.

If it is determined that the number of requests is equal to or less than the predetermined threshold (Yes at Step S106), the degeneracy control unit 205c resets the clean area 2012 in the secondary cache directory unit 201 (Step S107), and, after the completion of the reset, disconnects the clean area 2022 in the secondary cache data unit 202 (Step S108).

Then, after the degeneracy control is performed by the degeneracy control unit 205c, the activity ratio monitoring unit 205b receives the number of requests sent from the request counter 204 to the secondary cache in a predetermined period of time and determines whether the number of requests is equal to or greater than the predetermined threshold (Step S109). If the result of the determination is that the number of requests is not equal to or greater than the predetermined threshold (No at Step S109), the process returns to Step S109.

In contrast, if it is determined that the number of requests is equal to or greater than the predetermined threshold (Yes at Step S109), the revert control unit 205d promptly re-connects the clean area 2022 in the secondary cache data unit 202 (Step S105).

In the following, the flow of the cache registration process performed by the cache control device 200 according to the first embodiment will be described. As illustrated in FIGS. 4A and 4B, the cache control device 200 determines whether a request from the CPU 100 is a store instruction and whether there is a hit in the clean area 2022 in the secondary cache data unit 202 (Step S301).

If the result of the determination is that the cache control device 200 determines that the request is not the store instruction or determines that there is no hit in the clean area 2022 (No at Step S301), the cache control device 200 also determines whether there is a hit in the secondary cache data unit 202 (Step S302).

If the result of the determination is that the cache control device 200 determines that there is a hit in the secondary cache data unit 202 (Yes at Step S302), the cache control device 200 determines whether the replacement data in the primary cache is dirty data (Step S303).

If the result of the determination is that replacement data in the primary cache is dirty data (Yes at Step S303), the cache control device 200 writes back to the secondary cache in accordance with the invert flag (Step S304). Then, the cache control device 200 reads the requested data from the secondary cache data unit 202 and transfers the requested data together with a data invert flag to the CPU 100 (Step S315).

Furthermore, if the replacement data in the primary cache is not the dirty data (No at Step S303), instead of writing back to the secondary cache, the cache control device 200 reads the requested data from the secondary cache data unit 202 and transfers the requested data together with the data invert flag to the CPU 100 (Step S315).

In contrast, if the cache control device 200 determines, at Step S302, that there is no hit for the request from the CPU 100 in the secondary cache data unit 202 (No at Step S302), the cache control device 200 determines whether the request is a read instruction (Step S305). If the result of the determination is that the request is the read instruction (Yes at Step S305), the cache control device 200 determines whether there is free space in the clean area 2022 (Step S306). If the result of the determination is that there is free space in the clean area 2022 (Yes at Step S306), the cache control device 200 uses a free entry (Step S309).

If there is no free space in the clean area 2022 (No at Step S306), the cache control device 200 determines whether there is free space in the clean/dirty area 2021 (Step S307). If the result of the determination is that there is free space in the clean/dirty area 2021 (Yes at Step S307), the cache control device 200 uses a free entry (Step S309).

If there is no free space in the clean/dirty area 2021 (No at Step S307), the cache control device 200 determines that the area to be replaced is the clean area 2022 and creates free space by deleting an entry that is the least used entry in the clean area 2022 (Step S308).

Then, the cache control device 200 reads the data in the main storage 300 (Step S310) and determines whether the number of “1”s contained in the read data is greater than that of “0”s (Step S311). If the cache control device 200 determines that the number of “1”s contained in the read data is greater than that of “0”s (Yes at Step S311), the cache control device 200 inverts the data (Step S312). In contrast, if the cache control device 200 determines that the number of “1”s contained in the read data is less than that of “0”s (No at Step S311), the cache control device 200 does not invert the data (Step S313).

Thereafter, the cache control device 200 registers the data in the secondary cache data unit 202 (Step S314); reads the requested data from the secondary cache data unit 202 without writing back to the secondary cache; and transfers the requested data together with the data invert flag to the CPU 100 (Step S315).

In contrast, if the cache control device 200 determines that, at Step S301, the request from the CPU 100 is the store instruction and determines that there is a hit in the clean area 2022 in the secondary cache data unit 202 (Yes at Step S301), the cache control device 200 deletes the hit entry in the clean area 2022 (Step S316).

Then, the cache control device 200 determines whether there is free space in the clean/dirty area 2021 (Step S317). If the result of the determination is that there is free space in the clean/dirty area 2021 (Yes at Step S317), the cache control device 200 proceeds to Step S309 described above.

In contrast, if there is no free space in the clean/dirty area 2021 (No at Step S317), the cache control device 200 determines whether entry data that is the least used data in the clean/dirty area 2021 is clean data (Step S318).

If the result of the determination is that the entry containing data that is the least used data in the clean/dirty area 2021 is clean data (Yes at Step S318), the cache control device 200 determines that the area to be replaced is the clean/dirty area 2021. Then, the cache control device 200 creates free space by deleting an entry of clean data in the clean/dirty area 2021 (Step S319) and proceeds to Step S310 described above.

If the entry containing data that is the least used data in the clean/dirty area 2021 is not clean data (No at Step S318), the cache control device 200 determines that the area to be replaced is the clean/dirty area 2021. Then, the cache control device 200 transfers the dirty data together with invert information to the data restoring unit 103; allows the CPU 100 to write, in accordance with the invert information, the restored data to the main storage 300 so as to create free space (Step S320); and proceeds to Step S310 described above.

### Advantage of the First Embodiment

As described above, the cache control device 200 has, in the secondary cache data unit 202, the clean area 2022 that stores therein only information that is the same information as that stored in the main storage 300. The cache control device 200 monitors information on electrical power consumption of the cache control device 200; determines whether the information indicates that the electrical power consumption is equal to or greater than a predetermined threshold; monitors the activity ratio of the secondary cache memory; and determines whether the activity ratio is equal to or less than a predetermined threshold. Subsequently, if it is determined that the information indicates that the electrical power consumption is equal to or greater than the predetermined threshold or it is determined that the activity ratio of the secondary cache memory is equal to or less than the predetermined threshold, the cache control device 200 controls the clean area 2022 in the secondary cache data unit 202 such that the clean area 2022 is degenerated. Accordingly, in the process of the degeneracy control performed on the clean area 2022, the cache control device 200 does not need to write the dirty data to the main storage 300, thus promptly performing the degeneracy control process. Therefore, an advantage is provided in that the cache control device 200 can promptly reduce electrical power consumption without the size of the circuit being increased.

Furthermore, according to the first embodiment, if it is determined that the activity ratio of the secondary cache memory is equal to or less than the predetermined threshold, the cache control device 200 controls the clean area 2022 such that it is degenerated by resetting the cache directory that indicates the status of the data stored in the clean area 2022. Accordingly, when the cache is frequently used, the cache control device 200 can promptly re-connects the clean area 2022 in the secondary cache data unit 202.

Furthermore, according to the first embodiment, after the clean area 2022 is controlled such that it becomes degenerated, the cache control device 200 monitors the information indicates the electrical power consumption and determines whether the information on the electrical power consumption indicates that the electrical power consumption is equal to or less than the predetermined threshold. Furthermore, after the clean area 2022 is controlled such that it becomes degenerated, the cache control device 200 monitors the activity ratio of the secondary cache memory and determines whether the activity ratio is equal to or greater than the predetermined threshold. If the cache control device 200 determines that the information on the electrical power consumption indicates that the electrical power consumption is equal to or less than the predetermined threshold or determines that the activity ratio of the secondary cache memory is equal to or greater than the predetermined threshold, the cache control device 200 performs control such that the clean area 2022 is reverted. Accordingly, when the problem of excessive electrical power consumption is resolved or when the cache is frequently used, the cache control device 200 can immediately perform the revert process on the clean area 2022.

Furthermore, according to the first embodiment, if it is determined that the information on the electrical power consumption indicates that the electrical power consumption is equal to or less than the predetermined threshold, the cache control device 200 performs control such that the clean area 2022 in the secondary cache data unit 202 is reverted by resetting the cache directory stored in the clean area 2012. Accordingly, the cache control device 200 resets the clean area 2012 in the secondary cache directory unit 201 immediately before re-connecting the clean area 2022 and does not reset the clean area 2012 in the secondary cache directory unit 201 when performing the degeneracy control. Accordingly, the cache control device 200 can promptly disconnects the clean area 2022.

Furthermore, according to the first embodiment, the cache control device 200 monitors, as the information on the electrical power consumption of the cache control device 200, the temperature of the cache control device 200 and determines whether the temperature is equal to or greater than the predetermined threshold. Accordingly, by using the temperature of the cache control device 200, it is possible to determine whether the electrical power consumption of the cache control device 200 is high.

Furthermore, according to the first embodiment, the cache control device 200 monitors, as the activity ratio of the cache memory, the number of requests to the secondary cache data unit 202 in a predetermined period of time and determines whether the number of requests performed in the predetermined period of time is equal to or less than a predetermined threshold. Accordingly, by using the number of requests performed in the predetermined period of time, it is possible to determine whether the activity ratio of the cache memory is high.

### [b] Second Embodiment

The embodiment of the present invention has been described; however, the present invention is not limited to the embodiment described above and can be implemented with various kinds of embodiments other than the embodiments described above. Therefore, another embodiment included in the present invention will be described below as a second embodiment.

(1) System Configuration, etc.

The records of each device illustrated in the drawings are only for conceptually illustrating the functions thereof and are not necessarily physically configured as illustrated in the drawings. In other words, the specific shape of a separate or integrated device is not limited to the drawings; however, all or part of the device can be configured by functionally or physically separating or integrating any of the units depending on various loads or use conditions. For example, the degeneracy control unit 205c and the revert control unit 205d can be integrated. Furthermore, all or any part of the processing functions performed by each device can be implemented by a CPU and by programs analyzed and executed by the CPU or implemented as hardware by wired logic.

Of the processes described in the embodiments, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

(2) Program

The cache control method described in the embodiments can be implemented by a program prepared in advance and executed by a computer, such as a personal computer or a workstation. The program can be sent using a network such as the Internet. Furthermore, the program can be stored in a computer-readable recording medium, such as a hard disc drive, a flexible disk (FD), a CD-ROM, an MO, and a DVD. Furthermore, the program can also be implemented by the computer reading it from the recording medium.

According to the cache control device, an advantage is provided in that electrical power consumption can be promptly reduced without the size of the circuit being increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A cache control device comprising:
a cache memory that includes an identical-information storage area that stores therein data that is the same data as that stored in a main storage;
an electrical power consumption monitoring unit that monitors electrical power consumption information of the cache control device and that determines whether the electrical power consumption information indicates that the electrical power consumption is equal to or greater than a predetermined threshold;
an activity ratio monitoring unit that monitors an activity ratio of the cache memory and that determines whether the activity ratio is equal to or less than a predetermined threshold; and
a degeneracy control unit that degenerates the identical-information storage area in the cache memory when the electrical power consumption monitoring unit determines that the electrical power consumption information indicates that the electrical power consumption is equal to or greater than the predetermined threshold or when the activity ratio monitoring unit determines that the activity ratio is equal to or less than the predetermined threshold.

2. The cache control device according to claim 1, wherein when the activity ratio monitoring unit determines that the activity ratio is equal to or less than the predetermined threshold, the degeneracy control unit degenerates the identical-information storage area by resetting a cache directory that indicates the status of the data stored in the identical-information storage area.

3. The cache control device according to claim 1, wherein
after the degeneracy control unit degenerates the identical-information storage area, the electrical power consumption monitoring unit monitors the electrical power consumption information and determines whether the electrical power consumption information indicates that the electrical power consumption is equal to or less than the predetermined threshold, and
after the degeneracy control unit degenerated the identical-information storage area, the activity ratio monitoring unit monitors the activity ratio and determines whether the activity ratio is equal to or greater than the predetermined threshold, and
the cache control device further comprises a revert control unit that reverts the identical-information storage area when the electrical power consumption monitoring unit determines that the electrical power consumption information indicates that the electrical power consumption is equal to or less than the predetermined threshold or when the activity ratio monitoring unit determines that the activity ratio is equal to or greater than the predetermined threshold.

4. The cache control device according to claim 2, wherein
after the degeneracy control unit degenerates the identical-information storage area, the electrical power consumption monitoring unit monitors the electrical power consumption information and determines whether the electrical power consumption information indicates that the electrical power consumption is equal to or less than the predetermined threshold, and
after the degeneracy control unit degenerates the identical-information storage area, the activity ratio monitoring unit monitors the activity ratio and determines whether the activity ratio is equal to or greater than the predetermined threshold, and
the cache control device further comprises a revert control unit that reverts the identical-information storage area when the electrical power consumption monitoring unit determines that the electrical power consumption information indicates that the electrical power consumption is equal to or less than the predetermined threshold or when the activity ratio monitoring unit determines that the activity ratio is equal to or greater than the predetermined threshold.

5. The cache control device according to claim 3, wherein, when the electrical power consumption monitoring unit determines that the electrical power consumption information indicates that the electrical power consumption is equal to or less than the predetermined threshold, the revert control unit reverts the identical-information storage area by resetting the cache directory.

6. The cache control device according to claim 1, wherein the electrical power consumption monitoring unit monitors a temperature of the cache control device as the electrical power consumption information.

7. The cache control device according to claim 1, wherein the activity ratio monitoring unit monitors the number of requests sent to the cache memory in a predetermined period as the activity ratio of the cache memory.

8. A cache control method comprising:
monitoring electrical power consumption information of a cache control device;
determining whether the electrical power consumption information indicates that the electrical power consumption is equal to or greater than a predetermined threshold;
monitoring an activity ratio of the cache memory;
determining whether the activity ratio is equal to or less than a predetermined threshold; and
degenerating an identical-information storage area that stores therein data that is the same data as that stored in a main storage when it is determined that the electrical power consumption information indicates that the electrical power consumption is equal to or greater than the predetermined threshold at the monitoring of the electrical power consumption or when it is determined that the activity ratio is equal to or less than the predetermined threshold at the monitoring of the activity ratio.

9. A processor coupled to a storage comprising:
a processing unit that processes data; and
a cache memory that includes an identical-information storage area that stores therein the processed data that is the same processed data as that stored in the storage;
an electrical power consumption monitoring unit that monitors electrical power consumption information of the cache control device and that determines whether the electrical power consumption information indicates that the electrical power consumption is equal to or greater than a predetermined threshold;
an activity ratio monitoring unit that monitors an activity ratio of the cache memory and that determines whether the activity ratio is equal to or less than a predetermined threshold; and
a degeneracy control unit that degenerates the identical-information storage area in the cache memory when the electrical power consumption monitoring unit determines that the electrical power consumption information indicates that the electrical power consumption is equal to or greater than the predetermined threshold or when the activity ratio monitoring unit determines that the activity ratio is equal to or less than the predetermined threshold.
